(19) United States
(12) Patent Application Publication
(10) Pub. No.: US 2011/0011224 A1
(43) Pub. Date: Jan. 20, 2011

(54) SYSTEMS AND METHODS FOR REAL-TIME MONITORING OF DIE USE OR YIELD

(76) Inventor: Gary S. Levene, Kitchener (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/919,860

(22) PCT Filed: Mar. 2, 2009
(86) PCT No.: PCT/CA09/00247

§ 371 Date: Aug. 27, 2010

Related U.S. Application Data
(63) Continuation of application No. 61/032,320, filed on Feb. 28, 2008.

(51) Int. Cl. B26D 7/27; B26D 7/28

(52) U.S. Cl. 83/13; 83/72

(57) ABSTRACT

A method for monitoring die cutting comprising the steps of placing at least one cutting die on a hide, each cutting die having a particular pattern and an RFID (Radio Frequency Identification) tag coupled thereto, each RFID tag containing die-related information about that particular cutting die, repeatedly reading at least one RFID tag to obtain the die-related information for each RFID tag in real-time, based on the die-related information, determining whether the hide is ready for cutting, generating an output based on with whether the hide is ready for cutting, and when the hide is ready for cutting, cutting the hide.

### RELATED APPLICATIONS

This application claims the benefit of U.S. Provisional Patent Application Ser. No. 61/032,320, entitled SYSTEMS AND METHODS FOR REAL TIME TRACKING OF DIE USE OR YIELD, filed on Feb. 28, 2008 the entire contents of which are hereby incorporated by reference.

### FIELD

This specification relates to the field of die cutting.

### BACKGROUND

The following paragraph is not an admission that anything discussed therein is citable as prior art or part of the general knowledge of people skilled in the art.

Leather products, such as parts for an automobile interior (e.g. vehicle seating), may be made from pieces of leather cut to patterns. To cut the pieces of leather, dies or cavities may be made in the shapes of the patterns, placed on leather hides, and pushed through the leather using a press to cut the hides. Several die shapes may be needed to cut various distinct pieces that will be sewn together to create an end product. An order for a given number of end products, for example a given number of interiors of a given make and model of automobile, may require a certain number of pieces cut according to each pattern.

Leather hides tend to be very expensive and have irregular shapes and unique features (e.g. markings, etc., commonly known as flaws) that are particular to each hide. As a result, dies are often placed on the hides by hand in order to maximize the usage of acceptable leather.

A complete set of dies making up one final product is unlikely to efficiently fit on any one particular hide. Accordingly, a variety of different dies will often be fitted to the hide by a worker in an attempt to generate a good yield from each particular hide. A good yield is achieved when the amount of scrap (i.e. the unused material between dies) is reduced or minimized. However, the workers must end up with the correct number of pieces cut to each pattern to fill a particular order.

### SUMMARY

The following summary is intended to introduce the reader to this disclosure and not to define any invention or limit any claim. An invention may reside in any combination of any one or more process steps or apparatus elements selected from the set of all apparatus elements or process steps described in this disclosure.

A company cutting leather pieces for assembly into a desired number of products (e.g. automobile interior components) may wish to track the number of pieces cut to one or more patterns that are used to create the products. The company may also wish to determine the yield of cut products as a percentage of the area of a particular hide.

This disclosure generally describes systems and methods in which a device, such as an RFID (Radio Frequency Identification) tag, containing information related to a pattern identity associated with each die and optionally other information may be placed onto each die. The information contained on the RFID tag may include information about the die, and/or reference information that corresponds to information about the die that is stored in a remote database.

The RFID tags on dies placed on a hide for cutting may be polled to update a count of each pattern cut or to be cut. The count may be used to determine when enough pieces have been cut for an order or to provide an alert when a piece is about to be cut that is not required for the order.

Optionally, pieces can be cut for a subsequent order even if they are not presently needed. Further, the count may be compared to a desired number of pieces cut with a die to notify an operator of a remaining number of pieces still to be cut with the die.

This disclosure also describes systems and methods in which a hide may be scanned and fitted with a device, such as an RFID tag, having information related to the area of the hide, and optionally other information. Dies may be placed on the hide, and the RFID tags on the hide and on the dies polled. The RFID tags on the dies may contain information related to the area of a piece of material to be cut by that die. The total area of dies on the hide may be compared to a measured area of the hide to determine a yield from the hide. The yield from the hide may be compared to a desired or minimum yield, for example to provide an alert when the desired or minimum yield is not met.

In some examples, the placement of dies onto one or more hides may be monitored in real-time. This monitoring can be used to provide immediate or near immediate feedback to an operator who is placing the dies onto the hide, and may inform them that a particular piece is no longer needed, that a minimum yield has not yet been met, that an unknown piece has been found, or that additional area on the hide may still available for the placement of additional dies.

In some examples, one or more directional antennas may be used to monitor the placement of dies onto the hide in real-time or. Directional antennas may provide improved tracking of die placement, and may inhibit or reduce interference associated with reading of the RFID tags when compared to non-directional antennas.

In a first aspect, there is provided a method for monitoring die cutting comprising the steps of placing at least one cutting die on a hide, each cutting die having a particular pattern and an RFID (Radio Frequency Identification) tag coupled thereto, each RFID tag containing or referring to die-related information about that particular cutting die, repeatedly reading at least one RFID tag to obtain the die-related information for each RFID tag in real-time, based on the obtained die-related information, determining whether the hide is ready for cutting, generating an output based on with whether the hide is ready for cutting, and when the hide is ready for cutting, cutting the hide.

The generating of the output may include updating a count associated with each particular pattern for each cutting die.

The method may include the step of displaying the generated output including the updated count on at least one display.

The method may include the steps of comparing the count associated with each cutting die placed on the hide against an associated threshold count value, and determining if any cutting dies on the hide have exceeded their associated threshold count values.

The method may include at least one cutting die on the hide that has exceeded its associated threshold count value, and then an alert is generated.

The generating of the alert may include the step of identifying each cutting die that has exceeded its associated threshold count value and displaying the identity of each cutting die that has exceeded its associated threshold count on at least one display.

The method may include determining whether an order requiring a quantity of pieces to be cut by the die is complete.

The generating of the output may include the step of generating a die yield.

The die yield may be calculated based on the ratio of the sum of the areas of each cutting die placed on the hide to a hide area of the hide.

The die-related information of the RFID tag on each cutting die may include the area of that particular cutting die.

Each hide may have a hide RFID tag containing hide-related information affixed thereto, the hide-related information including the hide area for that hide.

The method may further include the step of reading the hide RFID tag in real time to obtain the hide-related information, and wherein the yield is calculated based on the die-related information and the hide-related information obtained by reading each cutting die RFID tag and the hide RFID tag.

Each hide may have a barcode tag containing hide-related information affixed thereto, the hide-related information including the hide area for that hide.

The method may include the steps of determining whether the yield meets a predetermined yield threshold value, and if the yield meets the predetermined yield threshold value, then determining that the hide is ready for cutting.

If the yield does not meet the predetermined yield threshold value, then an alert that the hide is not ready for cutting may be generated.

The generating the output may further comprise generating a count associated with each particular pattern for each cutting die.

The reading of each of the RFID tags may comprise scanning each RFID tag with an RFID antenna.

The step of reading the at least one RFID tag may further comprise performing a first read at a working table, moving the hide and cutting dies to an entry table, and performing a second read at the entry table.

The method may include the step of comparing the first read to the second read and generating an alert if the first read is different from the second read.

At least one of the RFID tags may be coupled to each cutting die using a separator.

At least one of the RFID tags that is coupled to each cutting die may be an active RFID tag. At least one of the RFID tags coupled to each cutting die may be a passive RFID tag.

When at least one cutting die is placed on the hide at a working table, the step of reading the at least one RFID tag may further comprise reading the RFID tag on each cutting die placed on the hide on the working table to identify each cutting die on the working table, comparing the identity of each cutting die on the working table against a predetermined group of cutting dies associated with the working table, and generating an alert when a cutting die placed on the working table is not a cutting die associated with the working table.

The output may be an alert output. The alert output may be a visual output, and the method may include the step of displaying the alert output on at least one display. The alert output may be an auditory output.

In a second aspect, there is provided a monitoring system for die cutting, comprising at least one cutting die, each cutting die having a particular pattern and an associated RFID (Radio Frequency Identification) tag coupled thereto and each RFID tag having die-related information about that particular cutting die. The system includes at least one RFID reader configured to be able to read the at least one RFID tag, and a controller in communication with the at least one RFID reader, the controller is configured to repeatedly trigger each RFID reader to read the RFID tag of each cutting die in real-time when the cutting dies are placed onto a hide. Based on the reading of the at least one RFID tag and its corresponding die-related information, the controller determines whether the hide is ready for cutting, and provides an output related to whether the hide is ready for cutting.

The die-related information for a given cutting die may comprise count information related to that cutting die.

The output may be based on comparing the count information for each cutting die on the hide to predetermined threshold count values.

The output may be an alert output when the count information of at least one cutting die on the hide exceeds its predetermined threshold count value.

The die-related information for each cutting die may comprise an area for that cutting die.

The controller may be further configured to calculate a yield based on the ratio between the sum of the areas of each cutting die on the hide and a hide area of the hide.

The at least one RFID reader may comprise at least one antenna communicably linked with the at least one RFID reader.

The RFID reader may comprise a plurality of antennas. The plurality of antennas may include a first set of antennas and a second set of antennas.

Each antenna in the first set of antennas may have a corresponding scan area and a corresponding working table, and the scan area for each antenna in the first set of antennas may cover at least a portion of its corresponding working table.

Each antenna in the second set of antennas may have a corresponding scan area, and at least one antenna in the second set of antennas may be associated with an entry table and having a scan area that at least partially covers the entry table.

The scan area being selected to avoid reading RFID tags that are not on the corresponding working table.

The system may include an entry table that is shielded from RF (radio frequency) signals other than the RF signals of its associated antenna.

The system may include a plurality of work tables, each work table having an associated antenna and a plurality of associated cutting dies.

The output may be an alert when the RFID tag of at least one cutting die on a given work table is read by the antenna associated with the work table and the cutting die is not within the plurality of associated cutting dies for that work table.

At least one RFID tag may be mounted to a surface of its corresponding cutting die. The surface may be on any component of the cutting die.

At least one RFID tag may be mounted to a surface of its corresponding die using a separator.

The controller may be communicably linked with a press and be operable to control the operation of the press based on at least a portion of the die-related information.

The controller may be configured based on programming provided in software format. The controller may be configured based on programming provided in hardware format.

The display may comprise a plurality of displays.

The system may include at least one hide RFID tag mounted to the hide, each hide RFID tag containing hide-related information and being readable by the RFID reader.

The die-related information may comprise work table assignment information. The die-related information may comprise a drawing of the cutting die area. The die-related information may comprise a name of the die.

The die-related information may comprise reference information that corresponds to a die-related data file stored in a database, the database being communicably linked to at least one of the controller, and the RFID reader.

### BRIEF DESCRIPTION OF THE DRAWINGS

FIG. 1 is a schematic view of a system for cutting pieces of leather with cavity dies according to one example;

FIG. 2 is a flow-chart illustrating a method of tracking or managing leather pieces cut according to another example;

FIG. 3 is a perspective view of a portion of a die fitted with an RFID tag according to another example;

FIG. 4 is a perspective view of a portion of a die fitted with an RFID tag according to another example;

FIG. 5 is a schematic view of a system for cutting pieces of leather with cavity dies according to another example;

FIG. 6 is a close up view of a nesting cell of the system of FIG. 5; and

FIGS. 7A to 7C are a flow-chart illustrating a method of tracking or managing leather pieces cut according to another example.

### DETAILED DESCRIPTION

This application hereby incorporates by reference the entire contents of PCT/CA2007/001474, entitled SYSTEMS OR METHOD FOR TRACKING DIE USE OR YIELD, filed on Aug. 28, 2007.

The following description will provide of an example of a system and method for real-time monitoring of die use or yield. However, one or more inventions may be disclosed in the following description without being claimed in this document and the claims in this document may not read on every apparatus or process or on every part of any particular apparatus or process described below. The inventors and their assigns do not disclaim any such invention or dedicate it to the public merely by not claiming it in this document.

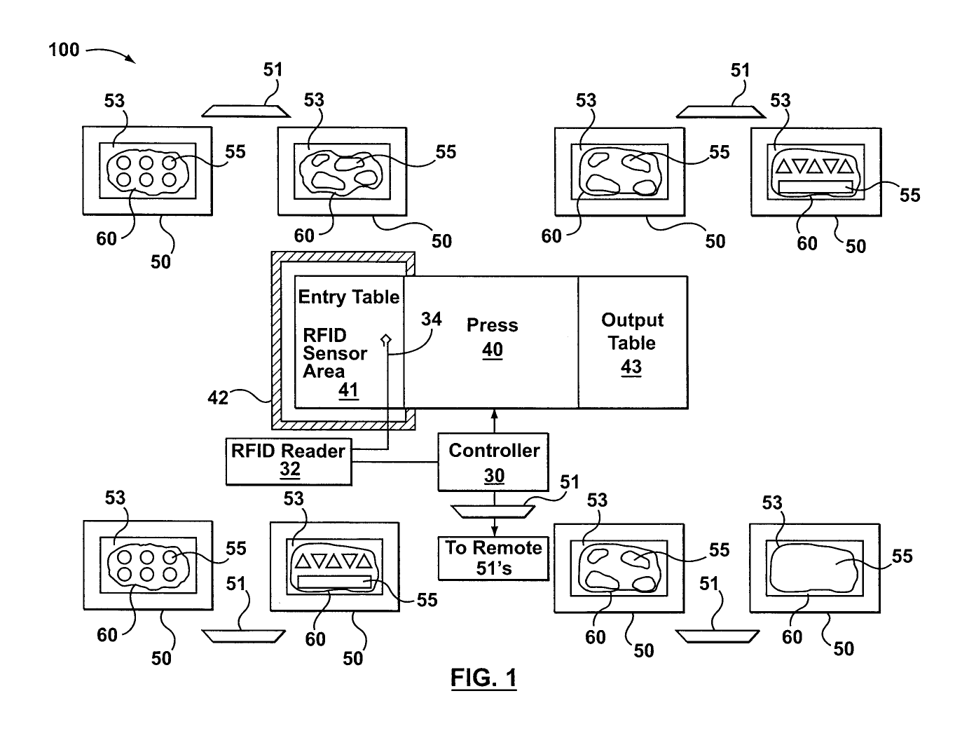

FIG. 1 shows a schematic view of a system 100 according to one example. The system 100 generally includes a controller 30, a press 40, a number of working tables 50 (alternately called nesting cells or layout tables), and a number of displays 51. In some examples, the press 40 may be a roller press, a beam press or any other cutting press or suitable apparatus which can apply downward or other pressure for causing a die (e.g. a cavity die) to cut through a hide (e.g. a leather hide or generally any other material to be cut).

The system 100 also includes a suitable combination of associated structural elements, communications systems, mechanical systems, hardware, firmware and software that is employed to support the function and operation of the system 100. Only selected items relating to the system 100 will be described below.

The controller 30 may include a computer or the like programmed and configured to receive data, display and/or transmit data and perform operations as will be described in further detail below. The controller 30 may also store information related to each die and hide used with the system 100. In some examples, such information may be stored in a database, a look-up table or using other known storage techniques.

Each entry in the database may be assigned a unique identifier, for example an alphanumeric identifier that may be encoded or stored on an RFID tag. Data stored remotely in the database (for example die-related data files) may be an alternative to, or in addition to, the information stored locally on each RFID tag. In some examples, the database may be stored on a separate remote server (not shown).

The press 40 is generally configured to apply pressure to cutting dies 55 arranged on leather hides 60 as they pass through or under the press 40. The press 40 thus causes the cutting dies 55 to cut the leather in the shapes of patterns associated with the dies 55. The press 40 as shown is arranged so that there is an output table 43 on one end and an entry table 41 on the other. Alternately, material to be cut may return to the entry table 41 and the output table 43 may be omitted.

In one example of a system, the entry table 41 also serves as the base of an RFID reading area and optionally may be provided with an RF shield 42 to prevent interference from tags not within the RFID reading area on the entry table 41.

An antenna 34 (or RFID sensor) is located so as to be able to read or poll RFID tags within the RFID reading area. The antenna 34 is connected to an RFID reader 32 that is in turn connected to the controller 30. Optionally, the antenna 34 and RFID reader 32 may be integrated into a single unit (the combined unit is also described as an RFID reader).

In operation, workers at the working tables 50 arrange cutting dies 55 with their cutting edges facing downward on top of hides 60 spread across cutting boards 53 on each working table 50. Once the cutting dies 55 are arranged, the cutting board 53 supporting a particular hide 60 and its respective dies 55 may be placed onto the entry table 41. In some examples, the cutting board 53 may be moved within the RF shield 42.

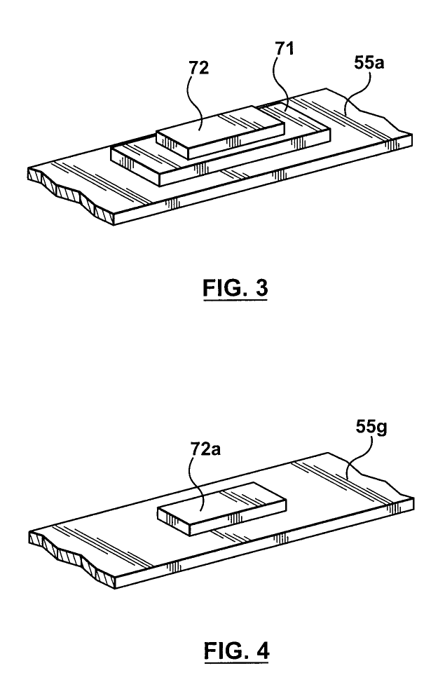

Each die 55 may have an RFID tag (indicated generally as 72 in FIG. 3, for example) mounted on it that has been previously encoded with manufacturing data, such as an alphanumeric series or unique identifier related to the identification of the shape or pattern cut by that particular die 55. The RFID tag 72 may also include other information, such as the area of the piece cut by the die 55, the manufacturer of the die 55, the end product that the die 55 is designed for, etc.

The RFID tags 72 may be passive tags or active tags. An active tag may be better suited if the tag 72 will be read on an entry table 41 adjacent the press 40, since an active tag may produce a stronger signal, which may allow the antenna 34 to be located further from the press 40 and may also tolerate greater electrical interference due to the surrounding environment.

On the entry table 41, the antenna 34 and reader 32 scan the entry table 41 to detect the presence of, and/or read, the tags on the dies 55. The identity of each die 55, and in some cases other information, may be sent by a communications system (not specifically shown) to the controller 30. In general, when the cutting board 53 is sent to the press 40, counts of the number of pieces cut with each die 55 may be updated. In the case of passive tags, the dies 55 may need to be passed or moved under the reader 32, as the signal strength may not strong enough to read all the dies 55 without moving.

In some examples, these counts can be stored by the controller 30 and displayed on the controller 30, on displays 51, output in other forms, and may be further manipulated, optionally in combination with other data such as time data, worker data (e.g. the name of the worker), etc. If sent to displays 51, such counts can provide workers with updates of the number of particular pieces of hide (or the dies 55 related to the particular pieces of hide) that still need to be cut and/or no longer need to be cut.

In some examples, the controller 30 may optionally send various alerts, such as an alert that an order has been filled or an alert advising that a cutting board 53 has been placed on the entry table 41 containing a die 55 for a piece no longer required.

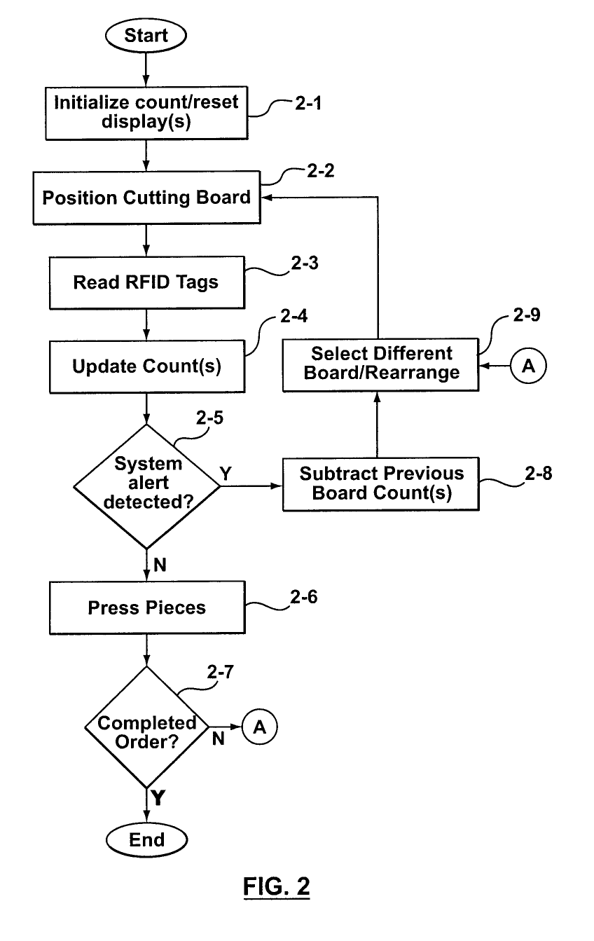

FIG. 2 shows a flowchart of an example of a method of tracking or managing the cutting of leather pieces using cutting dies.

Step 2-1 includes obtaining the identity and number of each pattern required for an order, initializing the count(s) for each pattern, and resetting the displays 51.

Step 2-2 includes positioning a cutting board 53 within the range of a reader, for example on the entry table 41, and preferably to the general exclusion of interference, such as could be provided by the RF shield 42.

Step 2-3 includes scanning (or reading) the tags on the dies 55 on the entry table 41 and sending information related to the identity of the patterns cut by the dies 55 to the controller 30.

Step 2-4 includes updating the count(s) for each pattern by the number of dies 55 related to that pattern on the cutting board 53.

Optionally, the cutting boards 53 may be scanned at one or more remote scanning tables, which could be the working tables 50 or nesting stations or at a different location. In some examples, this may be done if the area around the press 40 contains sufficient metal and electrical activity or interference so as to not interfere with reading the RFID tags. In such cases, the entry table 41 may be an ordinary infeed table for the press 40.

Optionally, a remote scanning table can be set up in an area of reduced interference, or where enhanced shielding can be provided, and the process operated as shown in FIG. 2, but with an additional step of moving the cutting board 53 from the remote scanning table to the entry table 41. Further, one or more remote scanning tables may be provided, each with an antenna 34 and reader 32, appropriate shielding if necessary, and a communications link to controller 30. In this way, multiple cutting boards 53 can have the counts of their dies 55 made and checked against maximum counts during overlapping time intervals, as will be described in greater detail below.

Before the cutting board 53 is put into the press 40, step 2-5 includes determining if a system alert has been detected. In some examples, a system alert may arise when a respective maximum count for a particular pattern has been exceeded. If a maximum count has not been exceeded (“NO” path, step 2-5), then the cutting board 53 on the entry table 41 can be sent to the press 40 for cutting. Accordingly, step 2-6 includes pressing the dies 55 on the cutting board 53 through the hide 60 in the press 40 and so cutting the leather into the shape of the die. In some examples, activation of the press 40 can optionally cause a message to be sent to the controller 30 to update a count of the number of hides 60 that have been cut.

On the other hand, if the required count of any pattern is exceeded (“YES” path, step 2-5), then the controller 30 may display an alert and the hide 60 on the entry table 41, or other scanning area or table, is not cut. Accordingly, step 2-8 includes subtracting from the updated count(s) tabulated at step 2-4 for each of the dies 55 on the entry table 41.

Optionally, each working table 50 may have an associated group of dies 55 that are supposed to be arranged on that table. In this example, a system alert may be generated if a die 55 is detected on a working table 50 that is not a member of the group of dies 55 associated with that particular working table 50. The presence and identity of each die 55 on the working table 50 may be determined by reading the RFID tag 72 of each die 55 on the working table 50 and comparing the identity of each die 55 to a list of associated dies 55 for the working table 50.

Optionally, a system alert may be generated if the yield on a given working table 50 or cutting board 53 falls below a predetermined threshold yield value. While various examples of system alerts have been described, other systems alerts may be created to meet a user's preferences.

Optionally, any alert generated may be overridden by a supervisor to allow parts for subsequent orders to be cut, rather than replacing all dies.

Following step 2-8, step 2-9 includes selecting a different cutting board 53 to be cut and/or rearranging or replacing the cutting dies 55 on the existing cutting board 53, for example by removing one or more dies 55 that are not desired, and, if possible, replacing them with one or more dies 55 that are still desired, before looping back to step 2-2.

After step 2-6, step 2-7 includes determining whether or not an order is complete, meaning that all the pieces that were desired for the particular order have been cut. If the order is not complete (“NO” path, step 2-7), the method proceeds through to step 2-9 as described above except that another cutting board 53, hide 60 and set of dies 55 may be brought to the entry table 41. On the other hand, if the order is complete (“YES” path, step 2-7), the method can end (as shown), and the controller 30 may send an alert that the order has been filled.

Step 2-7 may further include determining a number of pieces yet to be cut according to each pattern by subtracting the number cut of each pattern from the number required for that pattern. This may be done separately or as part of the process of determining whether an order is complete.

The number of pieces yet to be cut for one or more patterns, and a corresponding die or pattern identifier, may be displayed on one or more of the displays 51 or otherwise communicated to people working with the dies 55 or other people (e.g. supervisors). In this way, people working with the dies will have information letting them know which dies 55 they should attempt to use in rearranging a cutting board 53 or preparing a new cutting board 53.

Optionally, if the number of pieces cut for one or more patterns is exceeded for the current set, they may be tracked and count toward an additional set. Optionally, multiple sets can be specified for a single job, allowing pieces to be cut for multiple sets in mixed order.

Information may be displayed via text on the display 51, or by showing a graphical image of the die 55 on the display 51.

Turning now to FIG. 3, illustrated therein is a perspective view of a portion of a metal cutting die 55a fitted with an RFID tag 72. In order to reduce the possibility that skin effects from the metal cutting die 55a may interfere with the operation of the RFID tag 72, a separator 71 made from an insulating material may be provided between the RFID tag 72 and the die 55a.

Alternatively, as shown in FIG. 4, the metal cutting die 55g may be fitted directly with a RFID tag 72a. The RFID tag 72a is a metal resistant RFID tag. The performance of the metal resistant RFID tag 72a is acceptable despite its proximity to the metal cutting die 55g. The RFID tag 72a may be mounted directly on the surface of the cutting die 55g, without the use of the separator 71.

The RFID tags 72, 72a described in this specification may be chosen from commercially available active or passive RFID tags that are suitable for use in the system 100 environment. For example, some suitable tags may include Gen 2 Mini Metal RFID Tag—Passive Model 116502 (GAO RFID), Gen2 Ironside Tag—Passive Model 116403 (GAO RFID), RFID Tag—Prox (ABS Housing) Model 116029 (GAO RFID), Prox (Laminated Label Finish) Model 116026 (GAO RFID) and IT65 Small Rigid Tag (Intermec).

The RFID tags may be configured to operate at frequencies between 850 Mhz and 1000 Mhz.

Similarly, the RFID readers described in this specification may generally be selected from commercially available readers that are compatible with the selected RFID tag and the system 100 environment. For example, some suitable RFID readers may include Gen2 RFID Reader with Integrated Antenna Model 216003 (GAO RFID), Gen 2 RFID Reader/Writer with Built-in Antenna Model 216002 (GAO RFID), Enterprise Gen 2 RFID Reader—UHF: 902.75 MHz-927.25 MHz Model 216004 (GAO RFID), GEN 2 RFID Reader Model 216007 (GAO RFID), IF30 Fixed Reader (Intermec).

The antennas described in this specification may also be selected from commercially available antennas (including directional or non-directional antennas) such as UHF 902-928 MHz 7.5 dBi Reader Antenna—Circular Model 326005 (GAO RFID), Circular Polarized Antenna Model 326008 (GAO RFID), UHF 902 MHz. RFID Antenna—Circular Model 326001 (GAO RFID), UHF 902 MHz. RFID Antenna Circular Polarization Indoor Model 326003 (GAO RFID) and the IA39D Rugged Antenna (Intermec).

Optionally, the hides 60 may be scanned to determine their area. For example, a hide RFID tag 73 may contain hide-related information or act as an identifier pointing to a data file stored elsewhere (for example the controller 30 or other remote server (not shown)) which has information about the area of a particular hide. In some examples, other information such as a hide identifier (e.g. a unique indicator) or information related to the colour or source of the hide 60 may also be provided in a hide RFID tag 73. The hide RFID tag 73 is attached to the particular hide before the cutting dies 55 are placed on the hide. In another example, the hides 60 may be fitted with a different device that can be scanned to determine their area, such as a bar code tag.

Optionally, RFID tags 72 attached to dies 55 may also contain die-related information and/or act as an identifier pointing to a data file stored elsewhere (for example the controller 30 or other remote server (not shown)) which may contain information corresponding to the area of the piece cut by the die 55.

Optionally, this area information may be provided from a drawing file for the pattern of the die 55.

When a cutting board 53 is placed on the entry table 41 and the RFID tags 72 are read, the identity or area of the hide 60 and area or identity of the dies 55 may be collected and sent to the controller 30.

If only the identity of either the hide 60 or dies 55 is contained on the RFID tags 72, the controller may access a data file (e.g. stored on the controller 30 or other remote server or database) linking the hide 60 identifier or die 55 identifier with a corresponding area.

The collected information may be used to calculate a yield value by determining the area of hide 60 converted into cut pieces as compared to the total area of hide 60. This information may be used for a variety of purposes, for example to provide an indication that a minimum yield has been met or an alert when a minimum yield is not met.

For example, whether scanning is done at the entry table 41 or at one or more remote scanning tables, an indicator may be provided if the yield is above a minimum yield thus indicating to a person who prepared that particular cutting board 53 that the cutting board may be sent to the press 40.

Alternatively, an alert may be provided indicating that a minimum yield has not been met. This may be used to: inform the person that they should attempt to reconfigure the cutting board 53, prevent operation of a press 40 unless the alert is overridden by a supervisor, inform a supervisor of a below-yield cutting board 53, or a plurality of these uses. Optionally, and particularly where a working table 50 is a remote scanning area, the yield value may be shown on the display 51 near that working table 50.

The yield value may be updated by way of the person placing dies 55 instructing the reader 32 to make a reading. Alternatively, the yield value may be updated automatically by the controller 30 instructing the reader 32 to take readings at repeated or predetermined time intervals. Using either method, a revised yield number may be presented on the display 51 after a die 55 is placed on or removed from the cutting board 53.

In this way, the operator may gain information as to the effect of any particular removal or addition of a die 55 and so gain knowledge that will help him or her to reach a higher yield, or reach a desired yield more quickly, as well as indicating when a target yield is met. The information may also be used for other purposes, for example to provide statistics comparing yields associated with a particular employee, a plant, a source of hides, time period, etc.

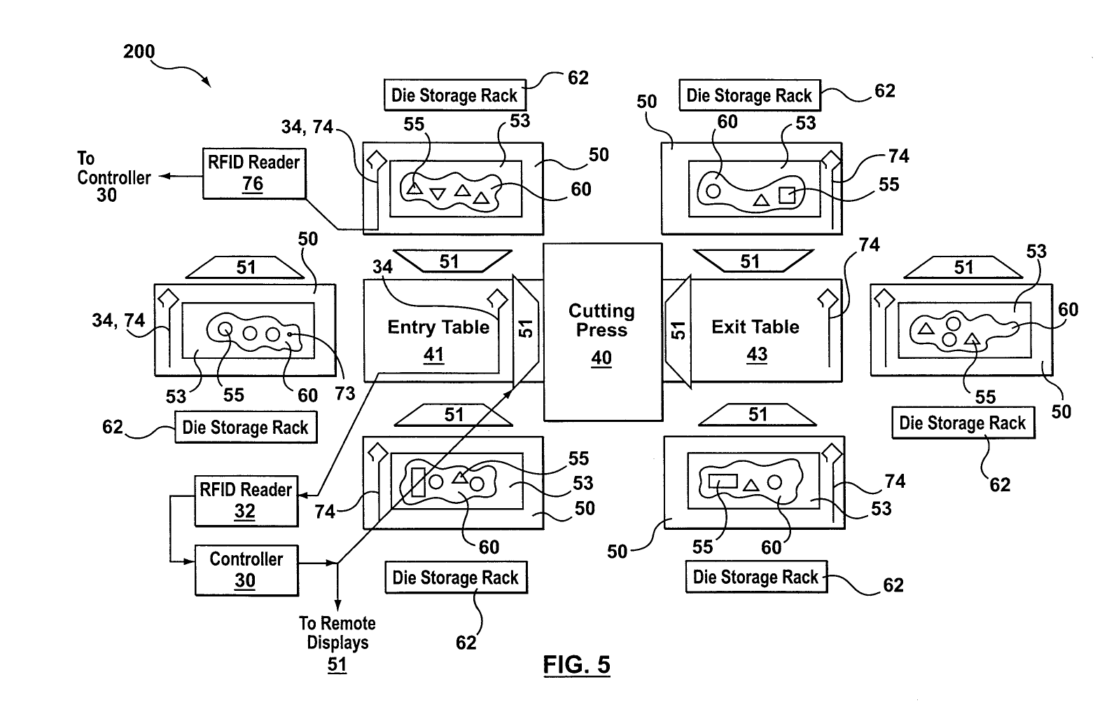

Turning now to FIG. 5, illustrated therein is a system 200 for tracking die use or yield. The system 200 includes similar elements to system 100, and where practical similar reference numerals have been used.

In particular, the system 200 includes a controller 30, a press 40, a number of displays 51 and a number of working tables 50. The system 200 also includes a suitable combination of associated structural elements, communications systems, mechanical systems, hardware, firmware and software that is employed to support the function and operation of the system 200. Only selected items relating to the system 200 will be described below.

The system 200 is configured to allow placement of cutting dies 55 onto leather hides 60 for the purpose of cutting various components and reporting back in real-time (or substantially in real-time) on the usage of the dies 55, and/or optionally on the yield (e.g. the total area of dies 55 placed on the hide compared to the area of the hide 60).

RFID tags 72 may be mounted onto the cutting dies 55 as described above. The tags 72 mounted on the dies 55 may contain die information or a reference to die information (e.g. the die number and program, the area of the die, the particular nesting station in which these dies are to be used at, and other manufacturing information).

RFID tags 72 may also be attached to the leather hides 60. The tags attached to the hides may contain hide information such as the program name, the area of the hide, the usable area of the hide, the color of the hide, and other information related to the hide.

As described above, the tags on both the hides 60 and the dies 55 may be read by means of an RFID antenna 34 and RFID reader 32 placed near the entry table 41 near the cutting press 40. Alternatively, in the system 200 as shown, additional directional RFID antennas 74 may be provided near or adjacent the working tables 50 or nesting cells.

The directional RFID antennas 74 may be configured to monitor placement of dies 55 onto the hides 60 as the operator works. The directional antennas 74 may monitor the placement of dies 55 in real-time or substantially real-time.

The information read by the RFID antennas may then be sent (optionally in real-time) to the central controller 30. The results may be stored in the controller 30, and may also be displayed to the operators via displays 51 (also optionally in real-time).

In this description, “real-time” is understood to mean the actual time that it takes the system to generally complete a tag reading or displaying process, without a user specified delay or other delay between the steps in the process. In this context, “real-time” does not necessarily mean that each task is completed within a fraction of a second, or in a matter of seconds, but rather that the tag reading and information displaying can be done quickly enough to provide feedback to a worker regarding the cutting die arrangement on a particular hide before the hide is sent through the cutting press. In some examples, “real-time” means that status of a particular hide (i.e. count information and/or yield information) at a working table 50 can be determined as the dies 55 are being placed on the hide and displayed to the worker before the worker moves the cutting board 53 to the entry table or cutting press.

For example, the controller 30 could track and display manufacturing details, such as the current number of cavities or dies placed onto the hide, the current yield as compared to required minimum yield, which parts or patterns are in greater demand than others, which current program is being cut, and any parts which are no longer required to be cut.

While the examples above describe the use of directional RFID antennas 74, non-directional RFID antennas could be used in place of, or in addition to the directional RFID antennas 74.

Each working table 50 (or entry table) may be provided with more than one RFID antenna. The RFID antennas 74 may be mounted to and supported by the working tables 50, or the RFID antennas 74 may be mounted on a separate structure that is in general proximity to the working tables 50 (e.g. a nearby wall, a beam, a rafter, an antenna support or a die storage rack).

The RFID antennas 34, 74 may be positioned toward one side or end of the working tables 50, as shown, or the antennas 34, 74 may be positioned in the centre of the working tables 50 or in any other suitable location that enables the antennas 34, 74 to read the RFID tags placed on the working tables 50, including above the tables, below the tables and generally at a plurality of positions around the perimeter of the tables.

If a particular cutting program or job is split over many nesting stations or working tables 50, the overall progress of the job could be reported to the shared displays 51 allowing complimentary balancing of the cut pieces between multiple operators.

Given the time taken to place the dies 55 and the short cycle time of the particular cutting press 40 being used, a number of working tables 50 with monitoring directional antennas 74 could surround the cutting press 40.

The dies 55 could be “assigned” to a given nesting area by storing this information in the tag 72 or a database in the controller. Should a die 55 be observed at a neighboring nesting area, the operator and/or a supervisor could be notified. The assignment of a particular die 55 to a particular working table 50 could be done during a “check-in” process, such as at the beginning of a shift for a particular operator or for a particular job.

The RFID antenna 34 and reader 32 could also be placed at the cutting press 40 to verify the readings from the directional antennas 74 to be sure that the parts are still required. This station could also be used to update a database of “cut parts”. Once the press has been started, the RFID antenna 34 and reader 32 could take a final read of the dies 55.

If the working tables 50 are in close proximity to each other, antennas that are not directional may tend to interfere with each other, reducing the overall performance of the system 200. Furthermore, such non-directional antennas may also read dies 55 from adjacent tables that are not meant to be read, resulting in read errors.

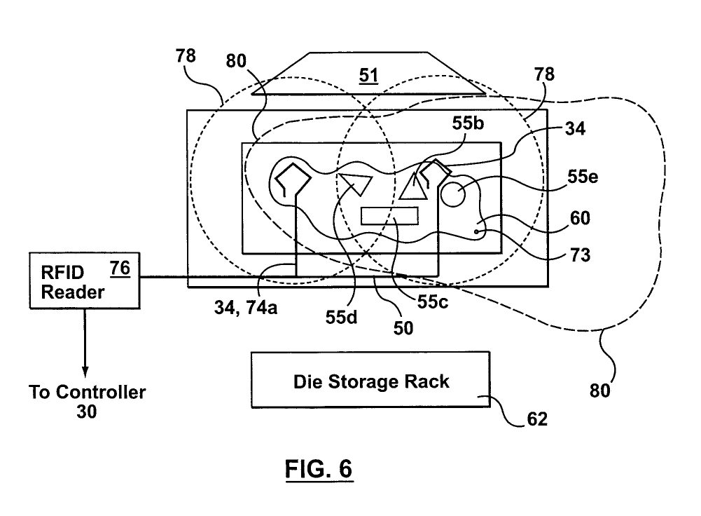

As shown in FIG. 6, two RFID antennas (direction antennas 74a or non-directional antennas 34 or a combination thereof) coupled to an RFID reader 76 may be used to monitor the placement of a plurality of dies 55b, 55c, 55d and 55e onto the hide 60. A conventional, non-directional RFID antenna 34 tends to radiate power in a generally uniform pattern or field about the antenna, such as fields 78 as shown in FIG. 6. Such a uniform radiation field 78 may not be desirable in some installations, for example where working tables 50 are placed in close proximity, as the uniform field 78 of neighboring antennas 34 may interfere. Furthermore, the uniform field 78 may interfere with other components, such as a display 51 or a die storage rack 62 placed near the working table 50.

In contrast, a directional antenna, such as directional RFID antenna 74a tends to radiate greater power in one or more specific directions (i.e. non-uniformly), tending to increase performance for transmitting and receiving of signals, and reducing interference from unwanted sources.

If a directional RFID antenna 74a is used it may radiate in a directional field 80, as shown in FIG. 6. The directional field 80 may be configured to reduce the interference caused by adjacent working tables 50, displays 51, die storage racks 62, and other interference sources. Depending on the details of a given installation, the working tables 50 may comprise two or more directional antennas 74a or non-directional antennas 74 or a combination thereof.

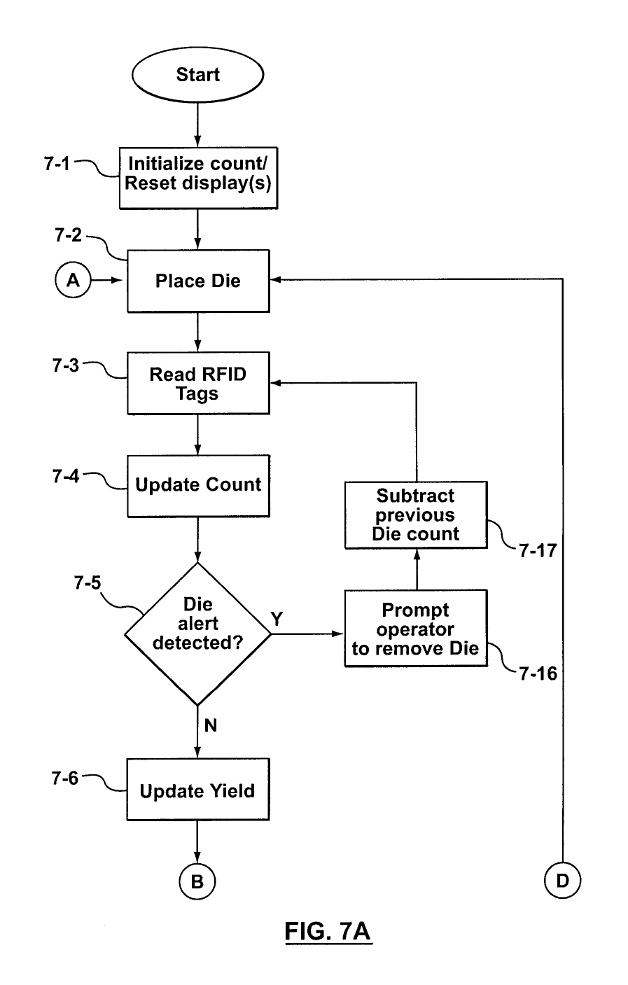

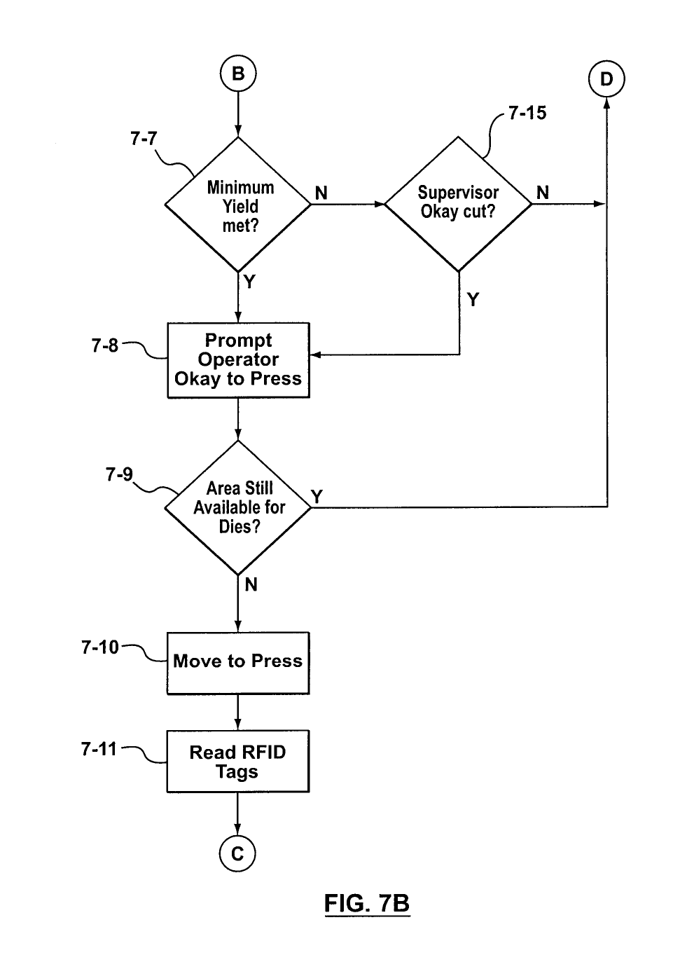

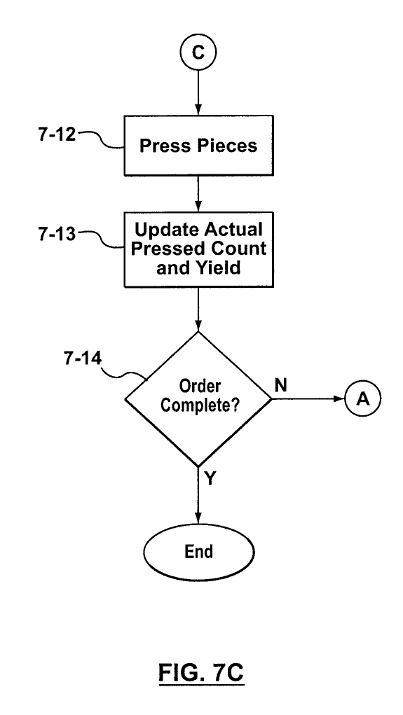

Turning now to FIGS. 7A to 7C, illustrated therein is a flowchart of a method of tracking and/or managing the cutting of leather pieces using cutting dies 55 according to another process.

Step 7-1 includes obtaining the identity and number of each pattern required for an order, initializing the count(s) for each pattern, and resetting the displays 51.

Step 7-2 includes placing at least one die 55 on a hide 60 on the working table 50.

Step 7-3 includes scanning (or reading) the tags on the dies 55 on the working table 50 and sending information related to the identity of the patterns cut by the dies 55 to the controller 30. In some examples, the scanning at step 7-3 may be done in real-time, for example as the operator places each die 55 onto the hide 60. In other examples, the scanning may be done at predetermined time intervals, such as every five seconds, every ten seconds, or at other suitable time intervals.

Scanning in real-time or at certain predetermined intervals may be advantageous, as the operators are quickly provided with feedback of the results of their die placements. Since the placement of dies 55 onto hides 60 tends to involve a high degree of manual manipulation of the dies 55 and determination by the operator of which particular dies 55 should be used with a particular hide 60, this feedback may assist the operator in making better choices in selection and placement of dies 55, improving overall efficiencies.

Step 7-4 includes updating the count(s) for each pattern by the number of dies 55 related to that pattern on the working table 50.

Step 7-5 includes determining whether a die alert has been detected. A die alert may include any type of alert based on the cutting dies 55 used on the working table. In one example, the die alert may be based on the presence of a foreign die 55 (i.e. a die 55 not associated with a given working table 50) or the count(s) for each die 55 used on the working table 50. For example, if the die alert is based on the count(s) of the dies 55 then step 7-5 includes determining if the count(s) for each pattern by the number of dies 55 exceeds a predetermined maximum as required for that particular job. In some examples, a supervisor may allow overages to achieve better yield with these parts being used in subsequent orders. In some examples, this determination may be done in real-time or substantially real-time. In other examples, the scanning may be done at predetermined time intervals, such as every five seconds, ten seconds, and so on.

If a die alert has not been detected (“NO” path, step 7-5), then the method proceeds to step 7-6. On the other hand, if any die alerts are detected at step 7-5 (“YES” path, step 7-5), then the method proceeds to step 7-16, as described below.

Step 7-6 includes updating the yield for the dies 55 placed onto the hide 60, for example, by adding the area of the at least one die placed at step 7-2 onto the hide 60.

At step 7-7, a determination is made as to whether the yield calculated at step 7-6 exceeds a predetermined minimum yield for that hide 60. In some examples, the minimum yield may vary depending on factors such as the type of hide being cut, the size of the hide, the number of flaws on the hide, the grade zones, the cost of the hide, the number and shape of dies 55 placed onto the hide 60 and remaining to be placed onto the hide 60, and so on.

If the minimum yield has been met (“YES” path, step 7-7), then the method proceeds to step 7-8. On the other hand, if at step 7-7 the minimum yield has not been met (NO″ path, step 7-7), then the method proceeds to step 7-15, as described below.

Step 7-8 includes notifying or prompting the operator that the particular hide 60 being worked on has been approved for pressing, and thus may be moved to the press 40.

Optionally, at step 7-9 a determination may be made that additional hide area is still available for placement of dies 55 onto the hide 60. This determination may be made manually (e.g. by the operator or a supervisor) or otherwise. If additional hide area is available (“YES” path, step 7-9), then the method returns to step 7-2. On the other hand, if at step 7-9 no additional hide area is available (“NO” path, step 7-9), then the method proceeds to step 7-10.

Step 7-10 includes moving the cutting board 53 with the hide 60 and dies 55 thereon to the press 40. This may be done manually (e.g. by the operator) or automatically (e.g. using a conveyor).

Optionally, at step 7-11a further reading of the RFID tags can be performed at the press 40, such as a reading by the RFID reader 34 to confirm the number and type of dies 55 on the hide 60.

Step 7-12 includes pressing the pieces of hide 60 using the press 40.

Step 7-13 includes updating the actual count of pressed pieces and/or the actual yield of the hide 60.

Step 7-14 includes determining whether all of the pieces for that particular order have been completed. If the order has been completed (“YES” path, step 7-14), then the method ends. On the other hand, if the order has not been completed (“NO” path, step 7-14), then the method returns to step 7-2.

Step 7-15 is optional, and allows the supervisor to determine whether the minimum yield requirement for a particular hide should be overridden. For example, when a limited number of parts are remaining to be cut, the supervisor may elect to override the minimum yield to ensure that only the required number of parts are cut. If the minimum yield is overridden (“YES” path, step 7-15), then the method proceeds to step 7-8. On the other hand, if the minimum yield requirement is not overridden (“NO” path, step 7-15), then the method returns to step 7-2.

Step 7-16 includes prompting the operator to remove at least one die 55 from the hide 60. In some examples, the operator may be prompted by a message provided on the display 51 and/or an audible alarm or otherwise. The prompt may further include details about which particular die(s) 55 are to be removed from the hide 60.

Step 7-17 includes subtracting the dies 55 removed by the operator from the previous die count.

While the above description provides one or more examples of an apparatus or process, another apparatus or process not described above may fall within the fair meaning and scope of the accompanying claims.

1. A method for monitoring die cutting comprising the steps of:
a. placing at least one cutting die on a hide, each cutting die having a particular pattern and an RFID (Radio Frequency Identification) tag coupled thereto, each RFID tag containing die-related information about that particular cutting die;
b. repeatedly reading at least one RFID tag to obtain the die-related information for each RFID tag in real-time;
c. based on the obtained die-related information, determining whether the hide is ready for cutting;
d. generating an output based on whether the hide is ready for cutting; and
e. when the hide is ready for cutting, cutting the hide.

2. The method of claim 1, wherein the generating of the output includes updating a count associated with each particular pattern for each cutting die.

3. The method of claim 2, further comprising the step of displaying the generated output including the updated count on at least one display.

4. The method of claim 2, further comprising the steps of:
comparing the count associated with each cutting die placed on the hide against an associated threshold count value; and
determining if any cutting dies on the hide have exceeded their associated threshold count values.

5. The method of claim 4, wherein, if at least one cutting die on the hide has exceeded its associated threshold count value, then an alert is generated.

6. The method of claim 5, wherein generating the alert further comprises the step of identifying each cutting die that has exceeded its associated threshold count value and displaying the identity of each cutting die that has exceeded its associated threshold count on at least one display.

7. The method according to claim 2, further comprising determining whether an order requiring a quantity of pieces to be cut by the die is complete.

8. The method of claim 2, wherein generating the output further includes the step of generating a die yield.

9. The method of claim 1, wherein generating the output includes calculating a die yield.

10. The method of claim 9, wherein the die yield is calculated based on the ratio of the sum of the areas of each cutting die placed on the hide to a hide area of the hide.

11. The method of claim 10, wherein the die-related information of the RFID tag on each cutting die includes the area of that particular cutting die.

12. The method of claim 11, wherein each hide has a hide RFID tag containing hide-related information affixed thereto, the hide-related information including the hide area for that hide.

13. The method of claim 12, further comprising the step of reading the hide RFID tag in real time to obtain the hide-related information, and wherein the yield is calculated based on the die-related information and the hide-related information obtained by reading each cutting die RFID tag and the hide RFID tag.

14. The method of claim 11, wherein each hide has a barcode tag containing hide-related information affixed thereto, the hide-related information including the hide area for that hide.

15. The method of claim 9, further comprising the steps of:
a. determining whether the die yield meets a predetermined die yield threshold value; and
b. if the die yield meets the predetermined die yield threshold value, then determining that the hide is ready for cutting.

16. The method of claim 15, wherein if the die yield does not meet the predetermined die yield threshold value, then generating an alert that the hide is not ready for cutting.

17. The method of claim 9, wherein generating the output further comprises generating a count associated with each particular pattern for each cutting die.

18. The method of claim 1, wherein the reading of each of the RFID tags comprises scanning each RFID tag with an RFID antenna.

19. The method of claim 1, wherein the step of reading the at least one RFID tag further comprises;
a. performing a first read at a working table;
b. moving the hide and cutting dies to an entry table; and
c. performing a second read at the entry table.

20. The method of claim 19, further comprising the step of comparing the first read to the second read and generating an alert if the first read is different from the second read.

21. The method of claim 1, wherein at least one of the RFID tags is coupled to each cutting die using a separator.

22. The method of claim 1, wherein at least one of the RFID tags is an active RFID tag.

23. The method of claim 1, wherein at least one of the RFID tags is a passive RFID tag.

24. The method of claim 1, wherein, when at least one cutting die is placed on the hide at a working table, the step of reading the at least one RFID tag further comprises:
a. reading the RFID tag on each cutting die placed on the hide on the working table to identify each cutting die on the working table;
b. comparing the identity of each cutting die on the working table against a predetermined group of cutting dies associated with the working table; and
c. generating an alert when a cutting die placed on the working table is not a cutting die associated with the working table.

25. The method of claim 1, wherein the output is an alert output.

26. The method of claim 25, wherein the alert output is a visual output.

27. The method of claim 26, further comprising the step of displaying the alert output on at least one display.

28. The method of claim 25, wherein the alert output is an auditory output.

29. A monitoring system for die cutting, comprising:
a. at least one cutting die, each cutting die having a particular pattern and an associated RFID (Radio Frequency Identification) tag coupled thereto, each RFID tag having die-related information about that particular cutting die;
b. at least one RFID reader configured to be able to read the at least one RFID tag; and
c. a controller in communication with the at least one RFID reader, the controller configured to repeatedly trigger each RFID reader to read the RFID tag of each cutting die in real-time when the cutting dies are placed on a hide, based on the reading of the at least one RFID tag and its corresponding die-related information, determine whether the hide is ready for cutting, and provide an output related to whether the hide is ready for cutting.

30. The system of claim 29, wherein the die-related information for a given cutting die comprises count information related to that cutting die.

31. The system of claim 30, wherein the output is based on comparing the count information for each cutting die on the hide to predetermined threshold count values.

32. The system of claim 31, wherein the controller output is an alert output when the count information of at least one cutting die on the hide exceeds its predetermined threshold count value.

33. The system of claim 29, wherein the die-related information for each cutting die comprises an area for that cutting die.

34. The system of claim 29, wherein the controller is further configured to calculate a yield based on the ratio between the sum of the areas of each cutting die on the hide and a hide area of the hide.

35. The system of claim 29, wherein the at least one RFID reader comprises at least one antenna communicably linked with the at least one RFID reader.

36. The system of claim 35, wherein the RFID reader comprises a plurality of antennas.

37. The system of claim 36, wherein the plurality of antennas further includes a first set of antennas and a second set of antennas.

38. The system of claim 37, wherein each antenna in the first set of antennas has a corresponding scan area and a corresponding working table, and the scan area for each antenna in the first set of antennas covers at least a portion its corresponding working table.

39. The system of claim 37, wherein each antenna in the second set of antennas has a corresponding scan area, and at least one antenna in the second set of antennas is associated with an entry table and having a scan area that at least partially covers the entry table.

40. The system of claim 38, wherein the scan area is selected to avoid reading RFID tags that are not on the corresponding working table.

41. The system of claim 39, wherein the entry table is shielded from RF (radio frequency) signals other than the RF signals of its associated antenna.

42. The system of claim 29, further comprising a plurality of work tables, each work table having an associated antenna and a plurality of associated cutting dies.

43. The system of claim 41, wherein the output is an alert when the RFID tag of at least one cutting die on a given work table is read by the antenna associated with the work table and the cutting die is not within the plurality of associated cutting dies for that work table.

44. The system of claim 29, wherein at least one RFID tag is mounted to a surface of its corresponding cutting die.

45. The system of claim 29, wherein at least one RFID tag is mounted to a surface of its corresponding die using a separator.

46. The system of claim 29, wherein the controller is communicably linked with a press and is operable to control the operation of the press based on at least a portion of the die-related information.

47. The system of claim 29, wherein the controller is configured based on programming provided in software format.

48. The system of claim 29, wherein the controller is configured based on programming provided in hardware.

49. The system of claim 29, wherein the display comprises a plurality of displays.

50. The system of claim 29, further comprising a hide RFID tag mounted to the hide, the hide RFID tag containing hide-related information and being readable by the RFID reader.

51. The system of claim 29, wherein the die-related information comprises work table assignment information.

52. The system of claim 29, wherein the die-related information comprises a drawing of the cutting die area.

53. The system of claim 29, wherein the die-related information comprises a name of the die.

54. The system of claim 1, wherein the die-related information comprises reference information that corresponds to a die-related data file stored in a database, the database being communicably linked to at least one of the controller, and the RFID reader.

55. The system of claim 29, wherein the output is generated in real-time.

56. A monitoring system for die cutting, comprising:
a. at least one cutting die, each cutting die having a particular pattern and an associated RFID (Radio Frequency Identification) tag coupled thereto, each RFID tag having die-related information about that particular cutting die;
b. at least one RFID reader configured to be able to read the at least one RFID tag; and
c. a controller in communication with the at least one RFID reader, the controller configured to repeatedly trigger each RFID reader to read the RFID tag of each cutting die when the cutting dies are placed on a material, based on the reading of the at least one RFID tag and its corresponding die-related information, determine whether the material is ready for cutting, and provide an output related to whether the material is ready for cutting.

57. The monitoring system of claim 56, wherein the controller is configured to trigger each RFID reader to read the RFID tags in real-time.
